(19) United States
(12) Patent Application Publication
(10) Pub. No.: US 2012/0068439 A1
(43) Pub. Date: Mar. 22, 2012

(54) Fast Hook-Up Hitch

(76) Inventor: Roger Fast, New Port Richey, FL (US)

(21) Appl. No.: 13/235,572

(22) Filed: Sep. 19, 2011

Related U.S. Application Data
(60) Provisional application No. 61/403,684, filed on Sep. 20, 2010.

(51) Int. Cl. B60D 1/06

(52) U.S. Cl. 280/511

(57) ABSTRACT

A hitch attached to a tow vehicle includes a plate slideably engaged within a plate receiver and having a ball mounted thereon. To attach the tow vehicle to a trailer, the tow vehicle is positioned such that the plate having the ball mounted thereto is placed in the vicinity of a ball receiver attached to the trailer. The plate is then repositioned manually until the ball is positioned directly under the ball receiver and the ball receiver is lowered onto the ball. After attachment of the ball to the ball receiver, the tow vehicle reverses causing the plate to advance into the plate receiver until a retainer pin locks the plate to the plate receiver thereby preventing the plate from moving relative to the plate receiver.

### RELATED APPLICATIONS

This application claims the benefit of U.S. provisional patent application Ser. No. 61/403,684 filed on Sep. 20, 2010, which is incorporated herein by reference in its entirety.

### FIELD OF THE INVENTION

This invention relates to vehicle towing devices and more particularly to a ball hitch.

### BACKGROUND OF THE INVENTION

Ball hitches are conventionally used to securely attach a towing vehicle to a camper, trailer or any other vehicle to be towed. A typical ball hitch includes a hitch post that fits securely into a hitch receiver disposed in the towing vehicle. A ball disposed on arm that extends from the hitch post engages a ball receiver attached to, for example, a tongue of a trailer. The ball receiver is shaped to fit snugly over the ball thereby securely attaching the towing vehicle to the trailer to permit towing thereof.

### BRIEF DESCRIPTION OF THE DRAWINGS

The detailed description is described with reference to the following set of drawings. The same reference numerals provided on different drawings indicate the same or similar items. The dashed lines shown in any of the FIGS. represent interior features of the hitch described herein or features that are otherwise hidden from view. Other advantages and aspects of the invention will become apparent upon reading the following description of the drawings and detailed description.

FIG. 1 is a perspective view of a hitch according to an example embodiment of the invention.

FIG. 2 is a side view of the hitch of FIG. 1 according to another example embodiment of the invention.

FIG. 3A is a top view of a plate receiver of the hitch of FIG. 1 according to another example embodiment of the invention.

FIG. 3B is a side view of the plate receiver of FIG. 3A according to another example embodiment of the invention.

FIG. 3C is another side view of the plate receiver of FIG. 3A according to another example embodiment of the invention.

FIG. 4 is a top view of a plate of the hitch of FIG. 1 according to another example embodiment of the invention.

FIG. 5 is a top view of the plate of FIG. 4 fully engaged in the plate receiver of FIGS. 3A, 3B and 3C according to another example embodiment of the invention.

FIG. 6 is a side view of the plate receiver, a standoff and a retainer pin of the hitch of FIG. 1 according to another example embodiment of the invention.

FIG. 7 is a top view of the plate of FIG. 4 in an unlocked, extended position relative to the plate receiver of FIGS. 3A, 3B and 3C according to yet another example embodiment of the invention.

### DETAILED DESCRIPTION

While this invention is susceptible of embodiment in many different forms, there are shown in the drawings and will herein be described in detail, examples of the invention with the understanding that the present disclosure is to be considered as an exemplification of the principles of the invention and is not intended to limit the broad aspect of the invention to the examples illustrated. The hitch and hitch components shown in the FIGS. are not drawn to scale, and are only intended to be representative.

Ball hitches are conventionally used to securely attach a towing vehicle to a camper, trailer or any other vehicle to be towed. A ball receiver attached to the tongue of a trailer is shaped to fit snugly over a ball hitch attached to a towing vehicle, thereby permitting towing of the trailer by the vehicle. However, in order to place the ball receiver on top of the ball, the ball must be positioned nearly exactly below the ball receiver. Given that the diameter of the ball is measured in inches, great precision is required on behalf of the driver to achieve the proper positioning between the ball and the ball receiver. Moreover, the driver must achieve this precision without being able to see the exact position of the ball or the ball receiver while backing up the vehicle. This process often entails a great deal of trial and error as the driver attempts to position the ball directly or nearly directly beneath the ball receiver. The ball hitch described herein reduces the precision required by the driver of the tow vehicle when positioning the ball for attachment to the ball receiver.

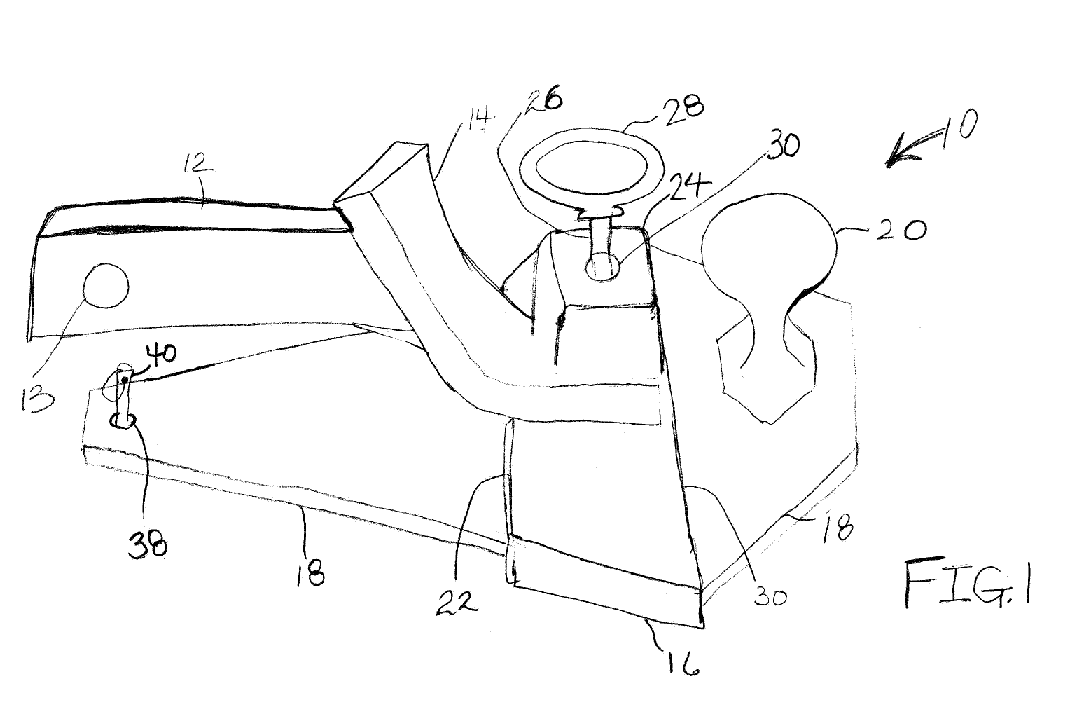

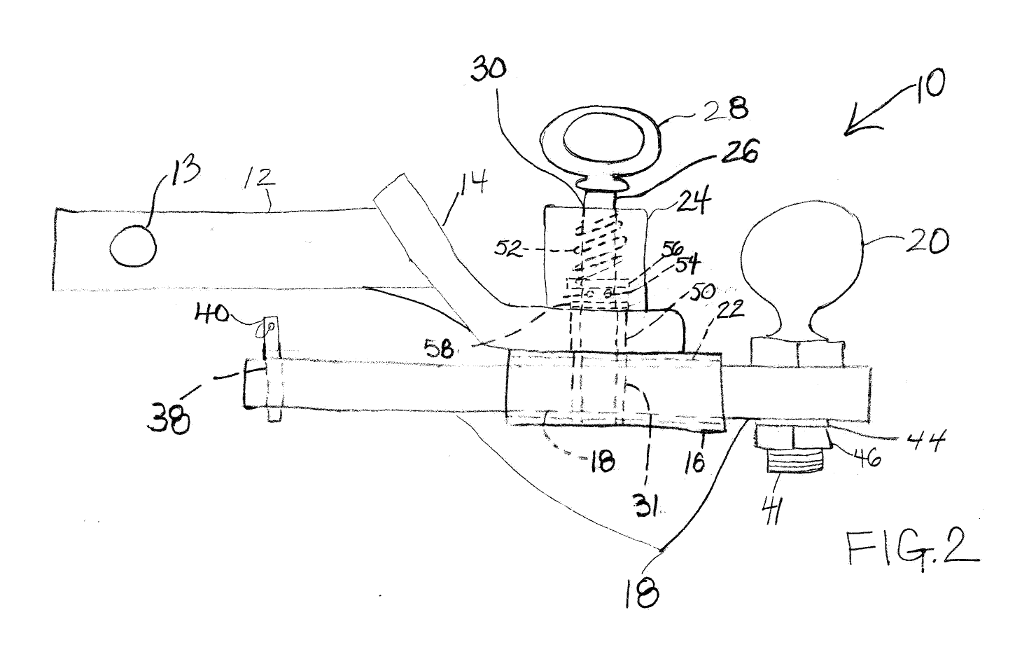

Referring now to FIG. 1 and FIG. 2, a ball hitch 10 comprises a standard hitch post 12 dimensioned to fit snugly within a standard hitch receiver (not shown) disposed on a tow vehicle (not shown). A set of holes 13 (one of which is shown) disposed on either side of the hitch post align with a set of holes disposed in the standard hitch receiver. A bolt placed into the channel created by the aligned holes holds the hitch post 12 securely within the hitch receiver (not shown).

Referring still to FIGS. 1 and 2, an arm 14 welded to the hitch post 12 is further welded to a plate receiver 16. A steel plate 18 having a ball 20 mounted at one end of the plate 18 extends through a channel 22 disposed in the plate receiver 16. A U-shaped standoff 24 disposed on top of the arm 14 supports a retainer pin 26 attached to a handle 28. The retainer pin 26 resides in a hole 30 disposed through the top of the U-shaped standoff 24 and extends through a channel 31 disposed through the arm 14, the plate receiver 16 and the plate 18 thereby locking the plate 18 and the plate receiver 16 together.

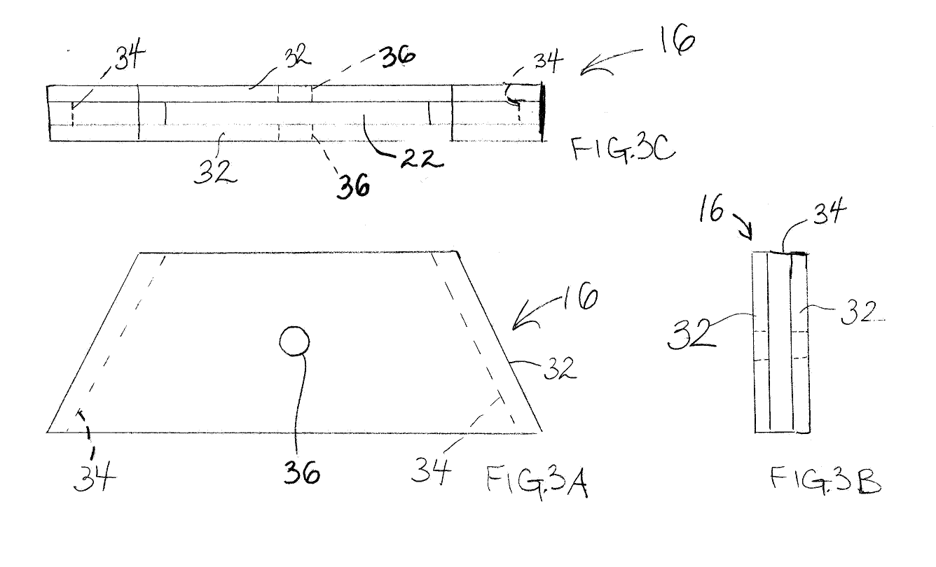

Referring also to FIGS. 3A, 3B and 3C, in one example embodiment, the plate receiver 16 comprises two steel plates 32 of the same shape that are biased apart by a set of steel spacer bars 34 to form the channel 22. A set of holes 36, one disposed in each of the steel plates 32, are positioned to align with one another.

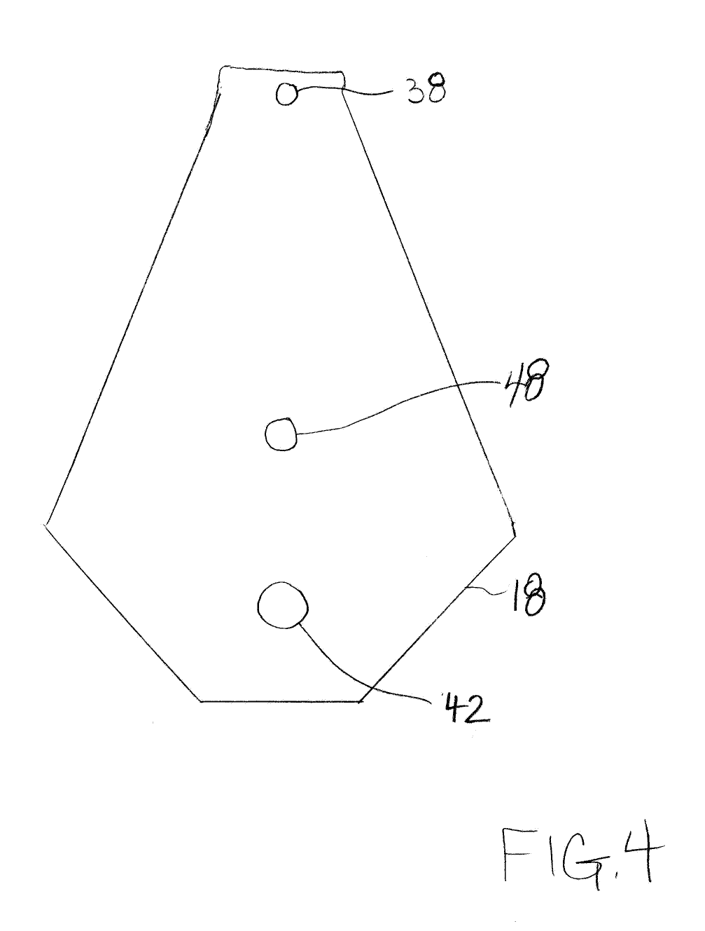

Referring now to FIGS. 3 and 4, in one example embodiment, the steel plate 18 is dimensioned to slide into the channel 22 of the plate receiver 16 and includes a hole 38 disposed at one end having a kotter pin 40 (see FIGS. 1 and 2) disposed therethrough to prevent the removal of the plate 18 from the plate receiver 16. The ball 20 (see FIGS. 1 and 2) which comprises a commercially available steel ball includes a threaded stem 41(see FIG. 2) that extends through a hole 42 disposed at another end of the plate 18 and is secured to the plate 18 via a lock washer 44 (see FIG. 2) and a threaded hex nut 46 (see FIG. 2).

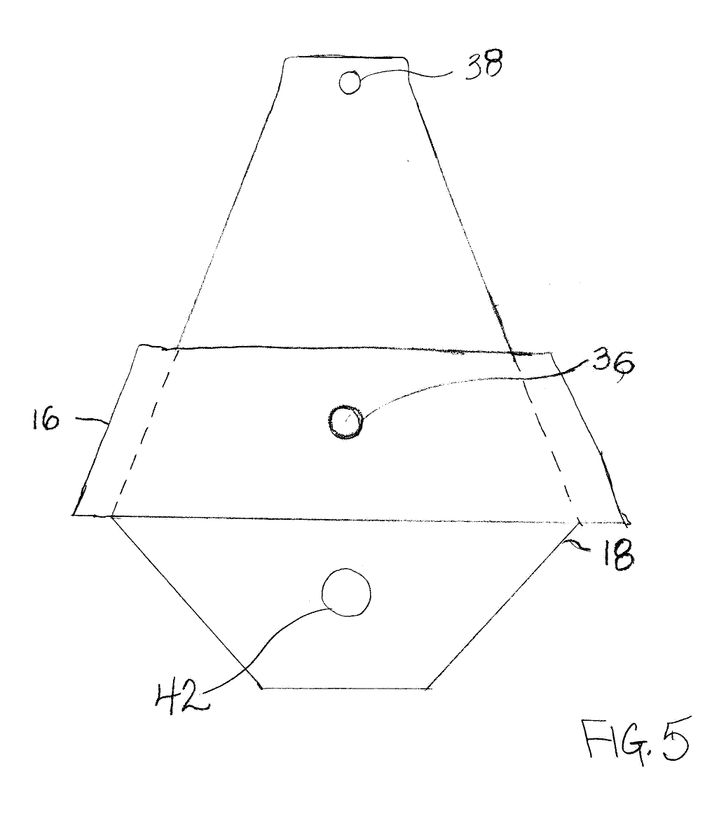

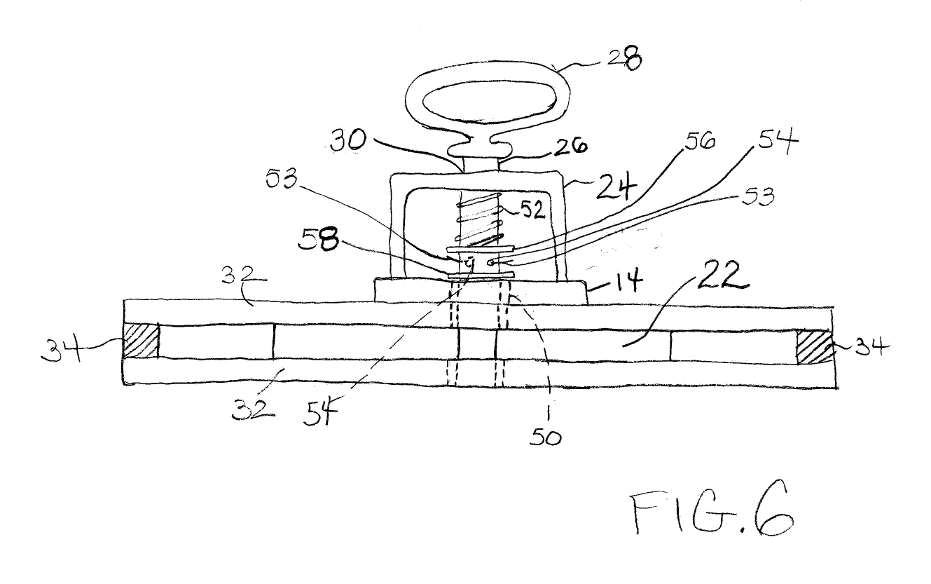

Referring also to FIG. 5 and FIG. 6, when the plate 18 is fully inserted into the plate receiver 16, a hole 48 (see FIG. 4) disposed in the plate 18 aligns with the holes 36 of the plate receiver 16 and a hole 50 disposed in the arm 14 to form the cylindrical channel 31 (see FIG. 2).

Referring still to FIGS. 5 and 6, the retainer pin 26 extends through a compression spring 52 having a spring key 53 which extends through the retainer pin 26 and protrudes from a set of holes 54 disposed in the retainer pin 26 to prevent the removal of the retainer pin 26 from the U-shaped standoff 24. A washer 56 extends around the retainer pin 26 and isolates the compression spring 52 from the spring key 53 to prevent the spring key 53 from becoming hooked onto or threading through the compression spring 52. The retainer pin 26 also extends through a washer 58 disposed between the arm 14 and the spring key 53 that is dimensioned to reduce the size of the opening of the hole 50 and thereby restrict the lateral movement of the retainer pin 26. The extension of the retainer pin 26 through the channel 31 (see FIG. 2) locks the plate 18 and plate receiver 16 together to prevent movement of the plate 18 relative to the plate receiver 16.

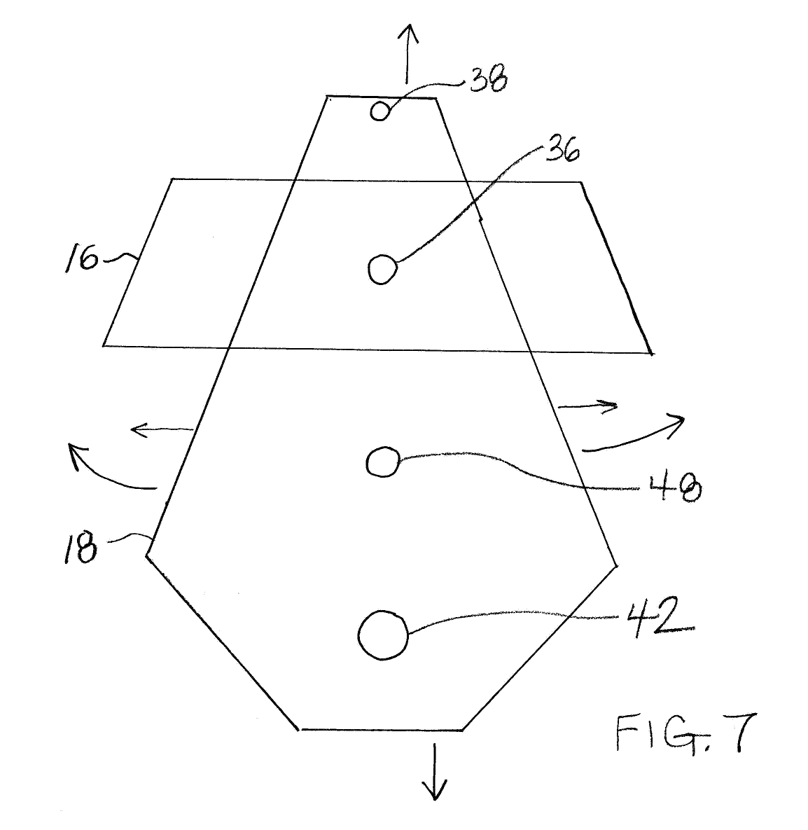

Referring also to FIG. 7, the plate receiver 16 and the plate 18 are unlocked by withdrawing the retainer pin 26 from the channel 31. Withdrawal of the retainer pin 26 permits the plate 18 to slide relative to the plate receiver 16 in a forward, backward, sideways and rotational motion. Note that although the plate 18 is permitted to slide relative to the plate receiver 16, the kotter pin 40 (see FIG. 1 and FIG. 2) remains in place preventing the plate 18 from becoming completely disengaged from the plate receiver 16. When the plate 18 and the plate receiver 16 are unlocked, the plate 18 is permitted to move into any of a number of extended positions limited only by the kotter pin 40 and the sides of the plate receiver 16. The space occupied by the plate 18 when in any of the extended positions is hereinafter referred to as the extension region.

Referring again to FIG. 2, when the retainer pin 26 is withdrawn from the channel 31(see FIG. 2) and the plate 18 is moved within the plate receiver 16 such that the channel 31 is blocked by the plate 18, the retainer pin 26 sits on top of the plate 18. When in this position, the compression spring 52 biases the retainer pin 26 in a downward manner such that when the plate 18 is fully engaged in the plate receiver 16 and the channel 31 is no longer blocked by the plate 18, the retainer pin 26 is forced downward into the channel 31.

To perform the hitching process the operator reverses the tow vehicle toward the standard ball receiver until the standard ball receiver (not shown) is within the extension region of the hitch 10. Next, the operator withdraws the retainer pin 26 thereby unlocking the plate 18 from the plate receiver 16 and manually moves the plate 18 until the ball 20 is directly beneath the ball receiver (not shown). The operator then lowers the ball receiver until the ball receiver sits securely on top of the ball 20. Finally, the operator further reverses the tow vehicle which causes the plate 18 to be pushed farther into the plate receiver 16. The operator continues to reverse the tow vehicle until the holes 36 of the plate receiver 16 and the hole 50 in the arm 14 align with the hole 48 of the plate 18 causing the retainer pin 26 to descend into the channel 31 and thereby locking the plate 18 to the plate receiver 16. The hitch 10 is now ready to tow the trailer, camper or other vehicle.

As will be appreciated by one having ordinary skill in the art, ball receivers are standardly equipped with a lowering and raising device that allows the ball receiver to be lowered onto the ball when hitching and to be raised off of the ball when unhitching.

As will further be appreciated by one having ordinary skill in the art, the hitch post 12 welded to the arm 14 having a hole 50 disposed therethrough is a standard, commercially available hitch device. The hole 50 disposed through the arm 14 is conventionally used to attach a commercially available steel ball.

Attaching the example hitch to a vehicle to be towed requires less precision and is thus easier than attaching a convention ball hitch. Specifically, when attaching the ball of the example hitch to a conventional ball receiver, the driver need only position the tow vehicle until the ball receiver is within the extension region of the hitch. The plate is then manually moved until the ball is disposed beneath the ball receiver so that the ball receiver can be lowered onto the ball. Reversing the vehicle toward the trailer forces the plate to advance further into the plate receiver until the plate becomes locked to the plate receiver. In contrast, when attaching a conventional ball hitch to a ball receiver, the tow vehicle must be positioned to place the ball directly under the ball receiver, a movement that requires much greater precision.

While example embodiments have been illustrated and described, numerous modifications may be made to the examples when making the sign displays. The scope of protection is only intended to be limited by the scope of the accompanying claims, either literally or under the doctrine of equivalents.

What is claimed is:

1. A hitch for attaching a first vehicle to a second vehicle for towing, the hitch comprising:
a post coupled to the first vehicle;
a receiver coupled to the post and having a first channel;
a plate slideably engaged within the first channel and having a ball mounted thereon; and,
a retainer pin positioned in a second channel disposed through the plate and the plate receiver to prevent movement of the plate relative to the plate receiver, wherein removal of the retainer pin from the second channel permits the plate to move relative to the receiver.

2. The hitch of claim 1, further comprising:
an arm coupled between the post and the receiver;
a standoff coupled to the arm to support the retainer pin in an upright position; and,
a spring positioned around the retainer pin to bias the retainer pin toward the second channel.

3. The hitch of claim 1 further comprising:
a second retainer pin disposed in a hole in the plate to prevent the plate from becoming disengaged from the receiver.

4. The hitch of claim 1 wherein the plate comprises a hole and wherein the receiver comprises a set of aligned holes and wherein the second channel is formed when the hole in the plate aligns with the holes in the receiver.

5. The hitch of claim 4 wherein the second channel is formed when the plate is fully inserted into the receiver.

6. The hitch of claim 1 wherein the receiver comprises two metal plates biased apart by a set of spacer bars and wherein the first channel is formed between the two metal plates.

7. The hitch of claim 1 wherein removal of the retainer pin from the second channel permits the plate to slide from side to side relative to the receiver.

8. The hitch of claim 1 wherein removal of the retainer pin from the second channel permits the plate to rotate relative to the receiver.

9. The hitch of claim 1 wherein the ball is dimensioned to attach to a ball receiver coupled to the second vehicle and wherein reversing the first vehicle with the ball attached to the ball receiver forces the plate to advance into the first channel until the retainer pin descends into the second channel to lock the plate to the receiver.

10. The hitch of claim 1 wherein the plate and the receiver are shaped such that placing a backward directed force onto the ball when the plate is in an extended position relative to the receiver causes the plate to advance into the first channel.

11. A hitch for attaching a first vehicle to a second vehicle for towing, the hitch comprising:
a post coupled to the first vehicle;
an arm coupled to the post;
a fixed member coupled to the arm and having a channel;
a sliding member slideably enaged in the channel of the fixed member and having a ball mounted thereon; and,
a locking member for preventing movement of the sliding member relative to the fixed member, wherein movement of the sliding member relative to the fixed member is enabled by disengaging the locking member.

12. The hitch of claim 11, further comprising:
a standoff coupled to the arm to support the locking member.

13. The hitch of claim 11 further comprising:
a retainer element to prevent the sliding member from becoming disengaged from the fixed member.

14. The hitch of claim 11 wherein the sliding member comprises a plate and wherein the fixed member comprises a plate receiver.

15. The hitch of claim 14 wherein the channel is a first channel and wherein the plate comprises a hole and the receiver comprises a set of aligned holes and wherein a second channel is formed when the hole in the plate aligns with the holes in the receiver.

16. The hitch of claim 15 wherein the locking member is a retainer pin that enters the second channel to prevent movement of the plate relative to the receiver.

17. The hitch of claim 15 wherein the receiver comprises two metal plates biased apart by a set of spacer bars and wherein the first channel is formed between the two metal plates.

18. The hitch of claim 16 wherein removal of the retainer pin from the second channel permits the plate to slide from side to side relative to the receiver.

19. The hitch of claim 16 wherein removal of the retainer pin from the second channel permits the plate to rotate relative to the receiver.

20. The hitch of claim 16 wherein the ball is dimensioned to attach to a ball receiver coupled to the second vehicle and wherein reversing the first vehicle when the ball is attached to the ball receiver forces the plate to advance into the first channel until the hole in the plate aligns with the holes in the receiver to form the second channel and wherein the retainer pin descends into the second channel to prevent movement of the plate relative to the receiver.
